(19) United States
(12) Patent Application Publication
(10) Pub. No.: US 2011/0229112 A1
(43) Pub. Date: Sep. 22, 2011

(54) Heating apparatus

(75) Inventors: Shinji Taniguchi, Hyogo (JP); Toru Odagaki, Hyogo (JP)

(73) Assignee: USHIO DENKI KABUSHIKI KAISHA, Tokyo (JP)

(21) Appl. No.: 13/064,192

(22) Filed: Mar. 10, 2011

(30) Foreign Application Priority Data
Mar. 16, 2010 (JP) 2010-058594

(51) Int. Cl. F27D 11/12

(52) U.S. Cl. 392/416

(57) ABSTRACT

A heating apparatus contains a chamber that has a space for placing a work piece, a filament lamp that has an arc tube, and a sealing portion provided at an end of the arc tube. The heating apparatus further contains a glass tube extending through the chamber. A cooling fluid is introduced into the glass tube. An end of the glass tube extends to an outside of the chamber. A sealing member seals the glass tube and the chamber. The filament lamp is arranged inside the glass tube.

### CROSS-REFERENCES TO RELATED APPLICATION

This application claims priority from Japanese Patent Application Serial No. 2010-058594 filed Mar. 16, 2010, the contents of which are incorporated herein by reference in their entirety.

### TECHNICAL FIELD

The present invention relates to a heating apparatus used for heating a silicon substrate when forming an antireflection film or a passivation film on the substrate of a crystalline silicon solar battery, and specifically relates to a heating apparatus in which a filament lamp is arranged in a glass tube passing through and supported by a chamber, while cooling fluid, such as air, is circulated in the glass tube to cool the filament lamp.

### BACKGROUND

From a viewpoint of global environmental issues, expectations for a solar battery, which directly converts sunlight energy into electrical energy, have been rapidly raised in resent years, as an energy source for the next generation. Although a polycrystalline silicon solar battery using a polycrystalline silicon substrate and a monocrystal silicon solar battery using a monocrystal silicon substrate are known as solar batteries, it is considered at present that such polycrystalline silicon solar batteries will be mainly produced. A particular subject matter to this polycrystalline silicon substrate relates to the passivation technology and the light confinement technology that overcome a problem of deterioration in properties caused by difference of the quality and the plane directions of the substrate for every crystal grain.

Japanese Patent Application Publication No. 2008-263189 discloses a coating apparatus, which forms antireflection coating or passivation coating on the silicon substrate surface of such a solar battery. The coating apparatus of the patent application publication is shown in FIG. 3, wherein two vacuum chambers 21 and 22 are arranged to be close to each other, and a conveyor 23 passes through both of the vacuum chambers 21 and 22, to extend through an inlet opening 26 and an outlet opening 27, wherein a Si wafer 24 is conveyed on this conveyor 23 and is treated by heat inside the chambers 21 and 22. In the vacuum chamber 21, filament lamps 25, which are infrared heaters, are arranged to be parallel to one another at constant intervals to preheat the Si wafer 24 that is conveyed on the conveyor 23. While the Si wafer 24 is moved inside the vacuum chamber 21, the Si wafer 24 is preheated by the filament lamps 25, and then it is conveyed to the vacuum chamber 22 located on a downstream side, in which a layer is deposited by a reactant sputtering process. In addition, vacuum pumps 28 and 29, a sputtering unit 30, an active gas supply unit 31, and a reactant gas supply unit 32 are provided.

According to the patent application publication, by heating the Si wafer using infrared heaters in the vacuum chamber to 400° C., or more, especially preferably to 500 or more, an advantageous effect is obtained regarding the deposition of the antireflection coating or passivation coating in the vacuum chamber, which is located on a downstream side. In addition, in recent years, improvements in the processing speed of a workpiece such as the Si wafer in a processing apparatus, to meet demand are required. Thus, it is desirable that the filament lamps, which serve as a heat source, have a property of a high temperature rise speed. To raise the temperature of the Si wafer to a high level and to increase a temperature rising speed of the filament lamps, which is a heat source, it is necessary to supply large current to the filament lamps.

However, in the coating apparatus described in the patent application publication, when such large current is supplied to the filaments, which are provided in the filament lamps 25 (infrared heaters), the temperature rises rapidly. However, since the filament lamps 25 are arranged in the vacuum chamber 21, there is a problem that the filament lamps cannot be cooled.

Therefore, since the temperature of sealing portions, which are formed to bury metallic foils in the end portions of the respective filament lamps, becomes high and since the heat resistance of the metallic foils is low, there is a possibility that the sealing portions are broken due to fusion-cutting of the metallic foil fuses.

### SUMMARY

The present invention related to a heating apparatus containing a chamber that has a space for placing a work piece, a filament lamp that has an arc tube, and a sealing portion provided at an end of the arc tube. The heating apparatus further contains a glass tube extending through the chamber. A cooling fluid is introduced into the glass tube. An end of the glass tube extends to an outside of the chamber. A sealing member seals the glass tube and the chamber. The filament lamp is arranged inside the glass tube.

Further, an infrared light reflective film may be provided on a surface of the glass tube, which corresponds to the seal members.

Furthermore, the infrared light reflective film may be formed on an inner surface of the glass tube.

Moreover, the infrared reflective film may have a diffusion and reflection face, which diffuses and reflects infrared light entering the infrared light reflective film.

In addition, the seal portion of the filament lamp, which is arranged on a downstream side of cooling fluid, such as air, may extend towards the outside of the glass tube.

### BRIEF DESCRIPTION OF THE DRAWINGS

Other features and advantages of the present heating apparatus will be apparent from the ensuing description, taken in conjunction with the accompanying drawings, in which:

FIG. 1 is a perspective view of an entire heating apparatus;

FIG. 2 is a cross sectional view of FIG. 1; and

FIG. 3 is an explanatory diagram of a heating apparatus of prior art.

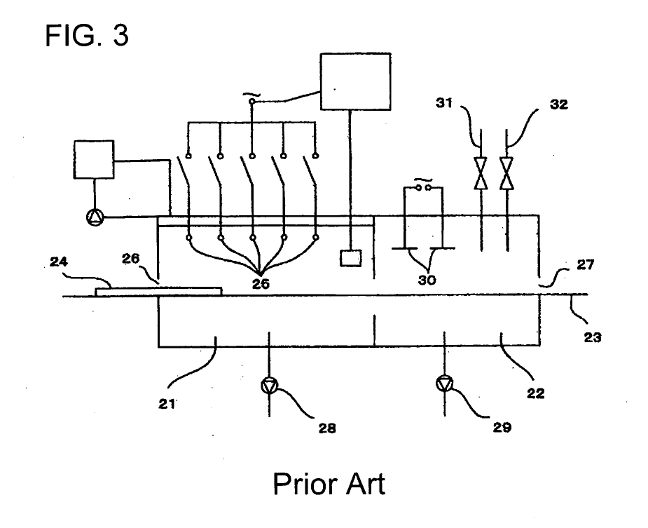

### DESCRIPTION

It is an object of the invention to offer a structure in a heating apparatus, which is equipped with filament lamps arranged in a vacuum chamber and has an arc tube and sealing portions at both ends, wherein the filament lamps, especially the sealing portions, can be efficiently cooled down, so that it is possible to prevent, in advance, the sealing portions from being broken, and high input to the filament lamps can be realized.

To solve the above-mentioned problem, a heating apparatus according to the present invention has a glass tube arranged to extend through a chamber so that both ends are respectively exposed to the outside of the chamber and cooling fluid is circulated therein, and sealing members, which seal respective portions between the glass tube and the chamber, where a filament lamp is arranged inside the glass tube.

Further, an infrared light reflective film may be provided on surface areas of the glass tube, which correspond to areas of the seal members. Moreover, an infrared light reflective film may be provided on an inner surface of the glass tube. Also, the infrared light reflective film may have a diffusion and reflection face, which diffuses and reflects infrared light entering the infrared light reflective film. Furthermore, the seal portions of the filament lamps, which are arranged on a downstream side of the cooling fluid, such as air, may extend to the outside of the glass tube.

In the heating apparatus of the present invention, since the filament lamps are arranged in the glass tube, to pass through the chamber, the filament lamps can be efficiently cooled down by circulating cooling fluid in the glass tube so that it is possible to increase an input applied to the filament lamps. Moreover, when the infrared light reflective films are formed on the surfaces of the glass tube, which face the sealing member between the glass tube and the chamber, the sealing members are not irradiated with the infrared light reflected within the chamber, so that it is possible to prevent deterioration of the sealing members due to heat. Moreover, when the infrared light reflective films are formed on the inner surface of the glass tube, the inside of the chamber is not contaminated by the component material of the infrared light reflective films. Moreover, since the infrared light reflective films have the diffusion and reflection face, the heat effect to the sealing members can be more effectively obtained. Furthermore, it is possible to prevent the temperature of the sealing portions from rising, by placing, in the outside the glass tube, part of the sealing portion of the filament lamps in the glass tube, which is located on a downstream side of the cooling fluid, such as air, and which tends to be high in temperature.

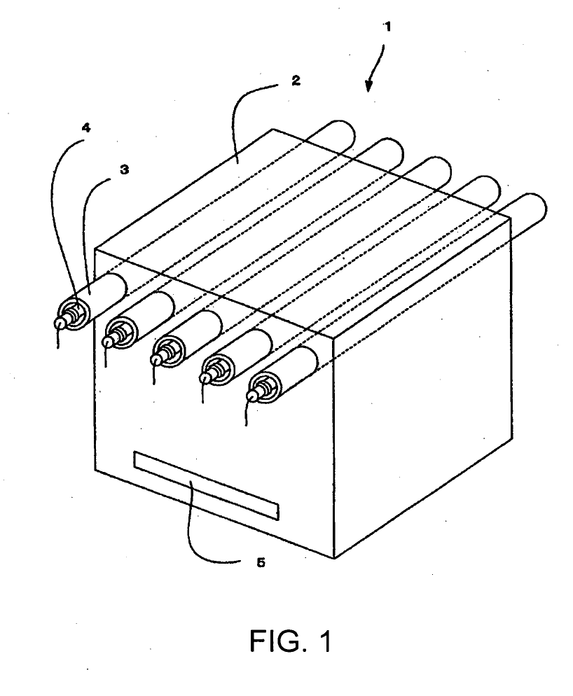

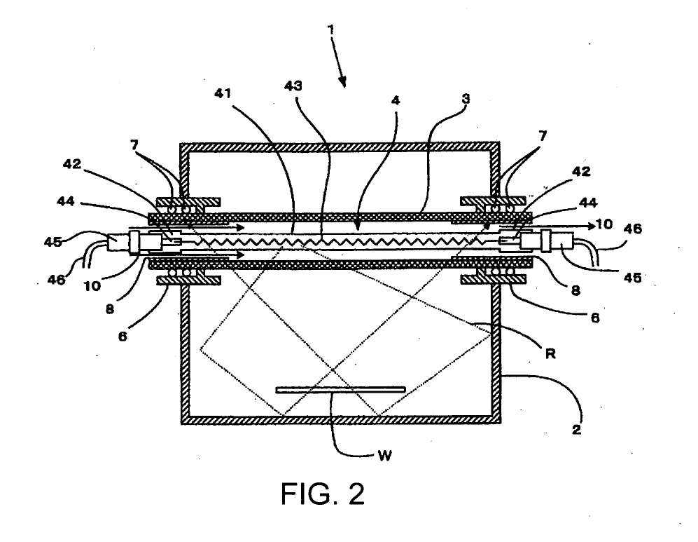

As shown in FIG. 1, a heating apparatus 1 is made up of a chamber 2, two or more glass tubes 3, which pass through and are supported by the chamber 2, and filament lamps 4, which are infrared heaters, are disposed in the respective glass tubes 3. In addition, a carrying-in opening 5 is formed on a lower side of the chamber 2. Moreover, the chamber 2 is connected with a discharge unit (not shown in FIG. 1), so that an internal space is brought into a predetermined vacuum state. As shown in FIG. 2 in detail, the glass tubes 3 are provided to pass through the chamber 2. Support blocks 6 are attached to both side walls of the chamber 2, and the glass tubes 3 pass through the support blocks 6 through sealing members 7, such as O rings, to be supported in an airtight state, wherein both ends of the glass tubes are projected outside the chamber 2. The infrared light reflective films 8 are formed on the inner surface of each glass tube 3 near the both ends. These infrared light reflective films 8 are made of material containing SiO2, Al2O3, ZrO2, or any combination thereof. And the surface is formed as a diffusion and reflection face, whereby an infrared reflex function is increased.

The above-mentioned infrared light reflective films 8 are provided on areas corresponding to the sealing members 7 in the inner surface of each glass tube 3 near the both ends, so as not to interfere with the infrared light R emitted from the filament lamp 4 towards a workpiece W, and so that the sealing members 7 and 7 may not be irradiated with the infrared light R reflected on the inner wall of the chamber 2. In addition, although the infrared light reflective films 8 may be formed on an outer surface of the glass tubes 3, if the infrared light reflective films 8 are formed on the inner surface, it is more suitable, since the inside of the chamber 2 is not contaminated by the material, which forms the infrared light reflective film 8.

The filament lamps 4 are inserted and disposed in the respective glass tubes 3, which pass through the chamber 2. Each of the filament lamps 4 has a cylindrical arc tube 41 made of, for example, silica glass, where seal portions 42 are formed at both ends of the arc tube 41. A coil-shape filament 43 is arranged inside each arc tube 41 to be coaxial with the arc tube 41, where halogen gas is enclosed. The coil-shape filament 43 extends in a longitudinal direction of the arc tube 41, and is connected to metallic foils 44 made of molybdenum within the seal portions 42 at both ends, respectively. Bases 45, each of which is made of insulating material and is formed in hollow cylinder shape, are placed around the respective seal portions 42, and power feeding lead wires 46 are connected to the respective bases 45.

Moreover, cooling fluid 10 flows therein from one end of each glass tube 3, is circulated inside the glass tube 3, and is discharged from the other end. The filament lamps 4 are cooled down during this process. In addition to the air, inactive gas such as nitrogen gas may be used as the cooling fluid 10.

In the above-mentioned structure, the workpiece W placed in the chamber 2, which is in a vacuum state, is irradiated with the infrared light R through the glass tube 3 from the filament lamps 4, whereby the workpiece W is heat-treated. The filament lamps 4, especially the seal portions 42, can be effectively cooled down by circulating the cooling fluid 10 in the glass tube 3 during this time. Moreover, although the infrared light R is reflected by the inner wall of the chamber 2, so that part thereof travels toward the sealing members 7 through the glass tube 3, it is reflected by the infrared light reflective films 8 formed on the glass tube 3, so that it is possible to prevent deterioration since the sealing members 7 are not irradiated with the infrared light R. Furthermore, the seal portions 42 of the filament lamps are not irradiated with the reflected infrared light R, so that it is also possible to prevent the seal portions 42 from being undesirably heated.

Moreover, by providing the infrared light reflective films 8 on the inner surface of the glass tube 3, it is possible to prevent the inside of the chamber from being contaminated due to the component material of the infrared light reflective films 8. In addition, when the surfaces of the above-mentioned infrared light reflective films 8 are formed as diffusion and reflection faces, the infrared light, which is incident on the infrared light reflective films 8, is diffused and reflected in all directions by the diffusion and reflection faces of the surfaces, so that it is possible to irradiate the sealing members 7.

In the above-mentioned embodiment, in view of a space-saving, it is desirable that the length of the filament lamps 4 in the length direction be made as short as possible, thereby setting it to a desirable size, whereby it is arranged in the glass tube 3 including the seal portions 42. However, in case where there is a certain room in the space, in view of cooling, it is advantageous to form the seal portions 42 to extend toward the outside of the glass tube 3. In such case, since the cooling air, which is circulated inside the glass tube 3, becomes a little higher in temperature on the downstream side, than that on the upstream due to cooling by the filament lamps 4, especially, if the seal portion 42 located on the downstream side is formed to extend towards the outside of the glass tube 3, it is suitable to prevent the temperature of the seal portions from rising.

As described above, in the heating apparatus according to the present invention, while the glass tube, which circulates the cooling air in the inside, is provided to extend through the chamber, and so that both ends may be exposed to the outside of the chamber, the sealing members, which seal areas between the glass tube and the chamber, are provided. Since the filament lamp is arranged inside the glass tube, cooling of the filament lamp, especially the seal portions, can be effectively performed, so that the effects are realized and that an input applied to the filament lamps is made high. In addition, since the infrared light reflecting films are formed on the areas of the surface, which correspond to the sealing members, the sealing members are not irradiated with the infrared light, which is reflected from the inside of the chamber, whereby it is possible to prevent deterioration of the sealing members.

The preceding description has been presented only to illustrate and describe exemplary embodiments of the present heating apparatus. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A heating apparatus comprising:
a chamber comprising a space for placing a work piece, a filament lamp comprising an arc tube, and a sealing portion provided at an end of the arc tube; the heating apparatus further comprising:
a glass tube extending through the chamber, a cooling fluid is introduced into the glass tube, an end of the glass tube extends to an outside of the chamber; and
a sealing member that seals the glass tube and the chamber, wherein the filament lamp is arranged inside the glass tube.

2. The heating apparatus according to claim 1, wherein an infrared light reflective film is provided on a surface of the glass tube, at a location of the seal member.

3. The heating apparatus according to claim 2, wherein the infrared light reflective film is formed on an inner surface of the glass tube.

4. The heating apparatus according to claim 2, wherein the infrared reflective film comprises a diffusion and reflection face that diffuses and reflects infrared light.

5. The heating apparatus according to claim 2, wherein the seal portion is arranged on a downstream side of cooling fluid, and extends towards an outside of the glass tube.
